(19) United States
(12) Patent Application Publication
(10) Pub. No.: US 2017/0197146 A1
(43) Pub. Date: Jul. 13, 2017

(54) REMOTE CONTROL WITH RELATIVE DIRECTIONAL SENSE TO A CONTROLLED OBJECT

(71) Applicant: Kenneth C. Miller, Aptos, CA (US)

(72) Inventor: Kenneth C. Miller, Aptos, CA (US)

(21) Appl. No.: 15/404,814

(22) Filed: Jan. 12, 2017

Related U.S. Application Data
(60) Provisional application No. 62/276,334, filed on Jan. 8, 2016.

(51) Int. Cl. A63F 13/57; A63F 13/213; A63F 13/211; A63F 13/98; A63F 13/215; A63F 13/2145; A63F 13/537; H04W 4/02; A63F 13/216

(52) U.S. Cl. CPC A63F 13/57; H04W 4/023; H04W 4/026; A63F 13/213; A63F 13/211; A63F 13/216; A63F 13/215; A63F 13/2145; A63F 13/537; A63F 13/98

(57) ABSTRACT

A remote device orientation system is provided that includes a remote control in electrical communication with a controlled object. Both the remote control and the controlled object include electronic inertial guidance systems. A device is configured to determine the relative orientation and frame of reference of the remote control with respect to the controlled object. A method operation to the remote device orientation system includes the establishment of an initial common vector between the remote control and the controlled object to determine an initial frame or reference. A delta angle is then calculated between the initial common vector and a current vector as the controller changes orientation. The controller calculated delta angle is then communicated to the controlled object and used to establish a new frame of reference for the controlled object.

### RELATED APPLICATIONS

This application claims priority benefit of U.S. Provisional Application Ser. No. 62/276,334 filed Jan. 8, 2016; the contents of which are hereby incorporated by reference.

### FIELD OF THE INVENTION

The present invention in general relates to the field of remote controls and in particular hand held remote controls that maintain a frame of reference between the controller and the moving controlled object.

### BACKGROUND OF THE INVENTION

Hand held remote control units for moving controlled objects illustratively including robots and other motorized land and air based vehicles are not able to correct for the controlled object's directional changes or changes in the orientation of the control unit itself relative to the controlled object as well as to changes in the orientation/direction of the controlled object in relation to the control unit. The changes in relation to the remote controller and controlled object often results in considerable confusion to a human user attempting to control the directional movement of a dynamically moving controlled object, and the problem is compounded when the human moves the controller to a different position or orientation while the controlled object is also in motion in two or more dimensional space.

Thus, there exists a need for an improved remote control device that assists the user in accounting for the changes of the relative orientation between one or more of the user, remote control device, and the moving object being controlled.

### SUMMARY OF THE INVENTION

A remote device orientation system is provided that includes a remote control in electrical communication with a controlled object. Both the remote control and the controlled object include electronic inertial guidance systems. A device is configured to determine the relative orientation and frame of reference of the remote control with respect to the controlled object.

A method operation to the remote device orientation system includes the establishment of an initial common vector between the remote control and the controlled object to determine an initial frame or reference. A delta angle is then calculated between the initial common vector and a current vector as the controller changes orientation. The controller calculated delta angle is then communicated to the controlled object and used to establish a new frame of reference for the controlled object.

### BRIEF DESCRIPTION OF THE DRAWINGS

The present invention is further detailed with respect to the following non-limiting specific embodiments of the present invention. The appended claims should not be construed as being limited to the specific devices so detailed.

FIG. 1 is a flow diagram for implementing an embodiment of the invention;

FIG. 2 is a top view of a master remote control component that compensates for orientation changes to both the remote control unit and a controlled object, relative to each other, without affecting directional control of the controlled object according to one embodiment of the invention;

FIG. 3 is a perspective view of a multi-function modular robot apparatus that compensates for orientation changes between itself and a remote control unit, without affecting directional control of the controlled object according to one embodiment of the invention;

FIGS. 4A-4C are perspective views of the multi-function modular robot apparatus of FIG. 3 according to one embodiment of the invention;

FIG. 5 is a screenshot of a virtual control overlay on a touch screen of a portable computing/gaming device, where the portable computing/gaming device compensates for orientation changes to both the remote control unit and a controlled object, relative to each other, without affecting directional control of the controlled object according to one embodiment of the invention;

FIG. 6 illustrates tracking and calibration of the control device of FIG. 4 using lights on the corners of a playing surface to define a virtual three-dimensional (3D) play space according to one embodiment of the invention;

FIG. 7 illustrates the use of a mesh/grid to track an augmented reality (AR) space according to one embodiment of the invention;

FIG. 8 illustrates the maintaining of registration of the augmented reality (AR) space to real space with rotation of the portable computing/gaming device in accordance with one embodiment of the invention;

FIGS. 9A and 9B are screenshots that illustrate the maintaining of a player's frame of reference with movement of the portable computing/gaming device in accordance with one embodiment of the invention;

FIG. 10 illustrates the multi-function modular robot apparatuses broadcasting position and orientation information to a corresponding remote control gaming device in accordance with one embodiment of the invention;

FIG. 11 illustrates touch control to move the multi-function modular robot apparatus to a desired location on a playing surface in accordance with one embodiment of the invention;

FIGS. 12A and 12B illustrate the use of electronically generated underlying playing fields or textures on the remote control gaming device for the use with the real life playing field in accordance with an embodiment of the invention;

FIG. 13 illustrates a perspective view of a robot controlled game played on a billiards surface in accordance with an embodiment of the invention;

FIG. 14 illustrates a virtual or game simulator view of the robot controlled game played on a billiards surface of FIG. 13 in accordance with an embodiment of the invention;

FIG. 15 illustrates an additional version of a virtual or game simulator view of a robot controlled game played on a surface in accordance with an embodiment of the invention;

FIG. 16A and 16C illustrate a series of screenshots for selection of an avatar for game play in accordance with embodiments of the invention;

FIGS. 17A and 17B illustrate game objectives in accordance with embodiments of the invention;

FIG. 18 is a screenshot of a game menu for player options in accordance with embodiments of the invention;

FIG. 19 is a screenshot of the Lab selection from the game menu of FIG. 18 in accordance with embodiments of the invention;

FIG. 20 is a screenshot of the Workshop selection from the game menu of FIG. 18 in accordance with embodiments of the invention;

FIG. 21 is a screenshot of the Zoz store selection from the game menu of FIG. 18 in accordance with embodiments of the invention; and

FIG. 22 is a screenshot of the Stadium store selection from the game menu of FIG. 18 in accordance with embodiments of the invention.

### DETAILED DESCRIPTION OF THE INVENTION

The present invention has utility as a remote control device that assists the user in accounting for the changes of the relative orientation between one or more of the user, remote control device, and the moving object being controlled. Remote control devices illustratively include dedicated remote devices, mobile computing devices, entertainment devices and tablets, and smart phones. Controlled objects illustratively include a robot, or a vehicle such a toy car, model boat, model airplane, or drone. Embodiments of the remote control may have a wired or wireless connection to the object being controlled.

Embodiments of the inventive remote control device and orientation system, add electronic location and orientation functionality to both the remote control unit and the controlled object to enable orientation changes to both the remote control unit and the controlled object, relative to each other, without affecting directional control, where for example in a specific embodiment a “Forward” signal will always drive the controlled object away from controller, a “Back” signal will drive the controlled object closer to controller, a “Left” command signal will drive the controlled object left, a “Right” command will drive the controlled object right, a “Spin Right” command will spin the controlled object clockwise, and a “Spin Left” command will spin the controlled object counter-clockwise—no matter the relative orientations of the controller and the controlled object. In a specific embodiment the inventive controller may be used with omni-bots which are able to change direction instantaneously without steering. The use of the inventive remote control may be extended to robots and other controlled objects moving above, below, or in the same plane as the controller.

Embodiments of the inventive control and orientation system include both electronic inertial guidance systems (computer, accelerometers, gyroscopes, magnetometers, etc.) and other devices with capabilities illustratively including visual, global positioning satellite (GPS), sound, radio waves, light, infra red (IR), laser, magnetic, etc. to determine the relative orientation of the controller with respect to the robot or controlled object. In an inventive embodiment, a given starting point and orientation for both the controller and controlled object is initially known, the relative position and orientation of each will be known and software may be implemented to account for changes, thus enabling consistent directional control of the remote controlled object.

In inventive embodiments, both the controlled object and the remote controller are assigned a unique “Frame of Reference”. The assigned frame of reference is used to provide an absolute position and orientation for both the remote control and the specific device being controlled Thus, the controlled object frame of reference is made relative to the frame of reference of the controlling device (radio control based controller, joystick, gamepad, mobile device, etc.). In addition, the controller's frame of reference may change dynamically due to the controller moving and rotating in absolute space, embodiments of the inventive system provide a solution that accommodates this dynamic nature of the “source” frame of reference, and communicates these changes in real-time to the controlled device (i.e., robot/vehicle).

In inventive embodiments, software is used to first establish an initial common vector between the controller and robot/object. This initial common vector may be either relative, a vector that initially establishes relative alignment between the controller and robot; or absolute, a vector that represents a real vector in absolute space such as magnetic north, GPS, or alignment signals generated by a fixed structure illustratively including a stadium or playfield or surface used for a robotic game. Once the initial common vector is established, the controlling device can easily calculate the delta angle between the initial common vector and the current vector as the controller changes orientation in real space by using the electronic inertial guidance systems described earlier. Through wireless communication channels (WiFi, Bluetooth, etc.) the controller may send its recalculated delta angle to the robot/vehicle, resulting in establishing a new frame of reference for the controlled device. As above, the controller's forward, back, left, and right directions will result in the robot/vehicle moving exactly in the directions desired, based on the controllers dynamic frame of reference.

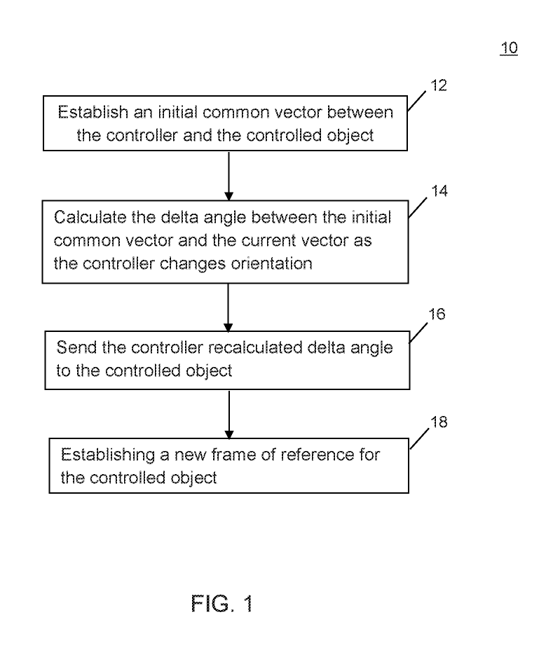

With reference to the attached figures, FIG. 1 is an embodiment of an inventive method 10 for implementing the inventive remote control with relative directional sense to the controlled object. The method starts with the establishment of an initial common vector between the controller and robot/object (step 12). This initial common vector may be either relative, a vector that initially establishes relative alignment between the controller and robot; or absolute, a vector that represents a real vector in absolute space such as magnetic north or GPS, or alignment signals generated by a fixed structure illustratively including a stadium or playfield or surface used for a robotic game. Once the initial common vector is established, the controlling device calculates the delta angle between the initial common vector and the current vector as the controller changes orientation in real space by using the electronic inertial guidance systems described earlier (step 14). Through wireless communication channels (WiFi, Bluetooth, etc.) the controller may send its recalculated delta angle to the robot/vehicle (step 16), resulting in establishing a new frame of reference for the controlled device (step 18).

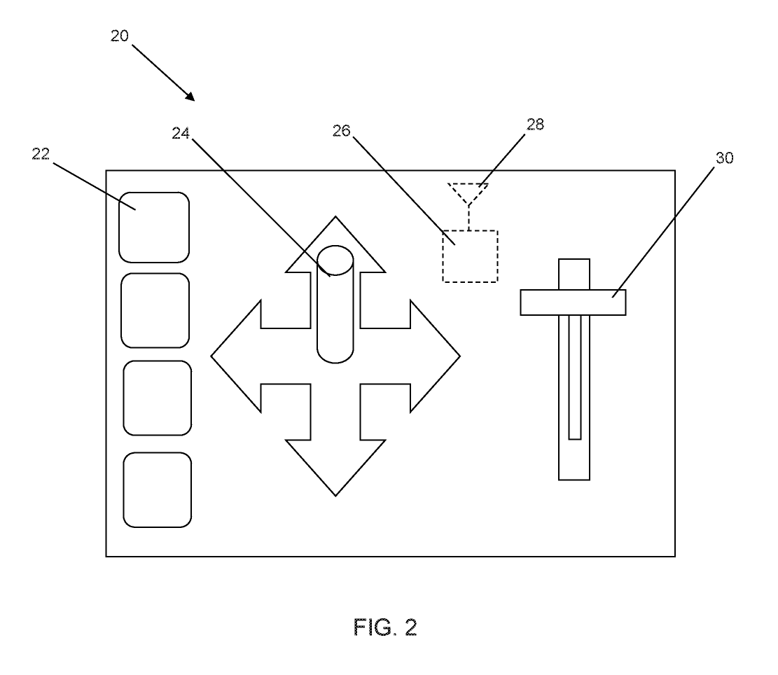

FIG. 2 is a top view of an inventive remote control 20 that compensates for orientation changes to both the remote control unit 20 and a controlled object, relative to each other, without affecting directional control of the controlled object. While the separate user operable remote control 20 is depicted herein as a handset with buttons 22, switches 30, and a joystick 24, it is appreciated that the separate user operable remote control 20 may also be a Smartphone, tablet, laptop or computer running an application (app). The remote control 20 may be configured with a location and electronic inertial guidance systems integrated circuits 26 with communication capabilities shown as antenna 28 for communication with the controlled object.

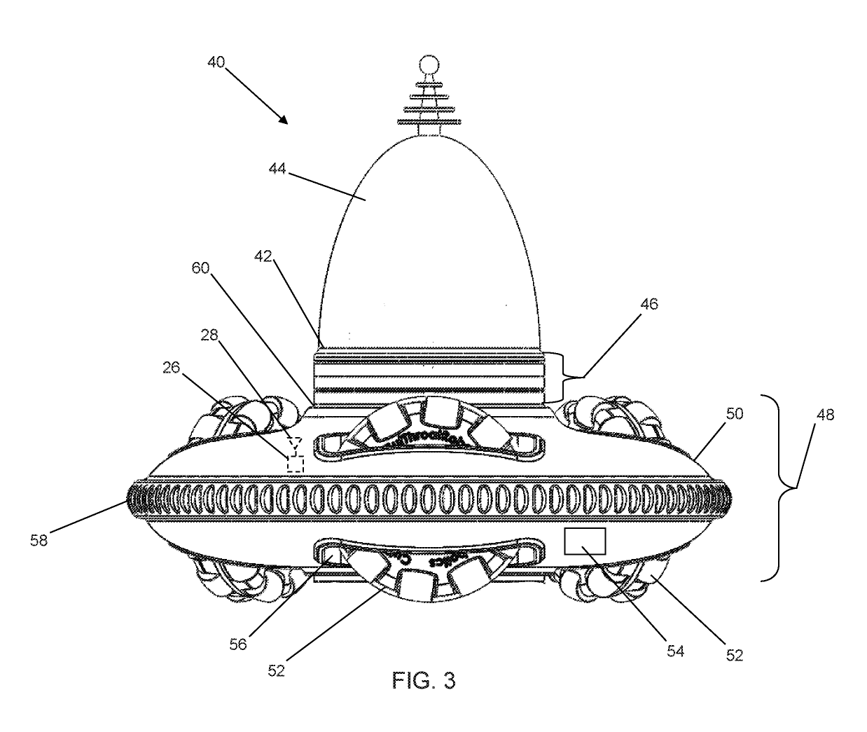

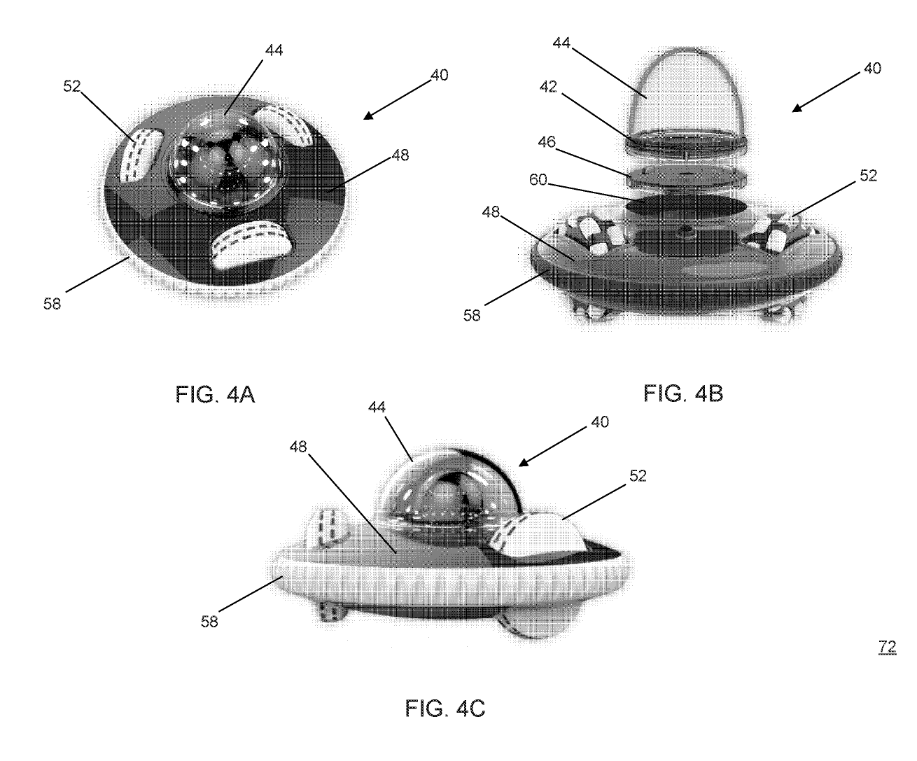

FIG. 3 is a perspective view of an inventive multi-function modular robot apparatus 40 that compensates for orientation changes between it and a remote control unit. Embodiments of the multi-function modular robot apparatus 40 are described in PCT Application MKC-117PCT herein incorporated in its entirety. The multi-function modular robot apparatus 40 in a specific embodiment may be referred to as a Zozbot or omnibot, where the robot 40 can move in any direction, instantaneously without steering of the wheels 52. The instantaneous directional changes are made possible with the three wheels 52 that are independently driven with separate motors 56 positioned in the robotic platform case housing 50 of the robotic platform 48. A bumper 58 is positioned along the circumference of the robotic platform 48. The robotic platform 48 has a module interface cutout 60 adapted to receive stackable modules 46, each module of the stackable modules 46 providing one or more functions illustratively including computer driver module, a motor driver module, a display module, a lights module, light emitting diodes (LED), a camera module, a sound and music module, a turret module, weapons module, inertial guidance system, and a communications module. Additional modules that may be added or interchanged in the stack include a telescope module, a weapons module, a tilting module, a spring module (for a bobble head), a bellows module, and a quick response (QR) code scanner module, robot arms, probes, sensors, a smoke and fog machine module, a universal serial bus (USB) port module, an infrared detector module, a laser range detector module, a sonic range detector module, a motion detector module, a multi laser light show module, a battery module, an auxiliary jack input module, a speaker module, a video projector module, a microphone module, a smoke detector module, and a carbon monoxide detector module. In certain inventive embodiments, a display module 42 contains a clear dome 44 positioned at the top of the stack 46 and has one or a combination of: video screen displays, avatars, heads, bobble-heads, arms, hands, sculptures, models, mini robots, animatronics and art. FIGS. 4A-4C provide perspective views of the multi-function modular robot apparatus of FIG. 3 according to one embodiment of the invention.

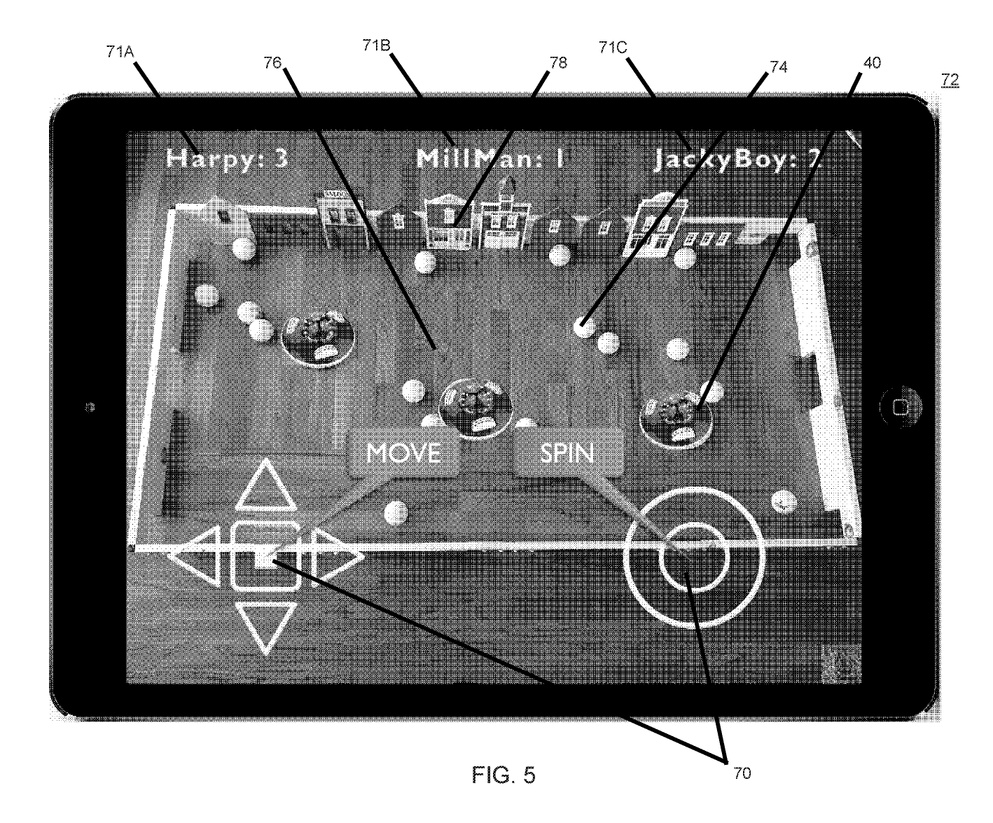

FIG. 5 is a screenshot of a virtual control overlay 70 on a touch screen of a portable computing/gaming device 72, where the portable computing/gaming device 72 compensates for orientation changes to both the remote control unit and a controlled object, relative to each other, without affecting directional control of the controlled object. As shown in the screenshot three players (71A, 71B, 71C) with current scoring are competing against each other using their robots 40. Each player has their own remote control device, which may or may not be identical as each individual may have their own version of the portable computing/gaming device 72 or keyboard, to control their respective robots. The playing field 76, which illustratively may include a floor, table top, billiards table, is enclosed with a perimeter wall 78 with goals or openings as disclosed in PCT/US14/52908 entitled “Robotic Game with Perimeter Boundaries” filed Aug. 27, 2014 and included in its entirety herein.

In the game shown in FIG. 5, the robots 40 attempt to score goals by pushing balls 74 through the openings (goals) in the perimeter wall 78. In specific embodiments the balls may be color-coded. In a single player training mode—one robot tries to clear the playing field of balls in the shortest amount of time. In multiplayer competitions a plurality of robots compete to clear their color-coded balls before their opponent(s). In specific embodiments some goals are worth more than others, and goals may be color-coded. In specific embodiments balls may explode when pushed through a goal, and goals may be guarded by gates that open and close. In specific embodiments a realistic physics engine simulates rigidbody interactions between robots, balls, and playing field. In specific inventive embodiments audio is generated for physical interactions, as well as optional background music, and user interface (UI) audio for countdown timing. A match countdown timer may be displayed in the UI, and when the counter reaches zero the match is ended. If a player clears the playfield before the match time, they are awarded bonus points based on the time left. Persistent data of match results are stored to track the high score and shortest match time. Versions of the game are available for various computer operating systems (OS) illustratively including Windows and Mac. Embodiments of the inventive game incorporates the best aspects of: billiards and multiplayer competition; mini-golf with moving gates in front of goals; pinball with bumpers; shooting gallery with the use of weapons to score points; Rube Goldberg scenarios/mousetrap with a mad cookoo clock; Midway type games with knocking over targets; and team competitive sports such as soccer.

Progression of game play ranges from training, beginner, intermediate, and advanced. The training level refers to a gamming situation with one player where the targets are pucks (high friction) where any gate counts as a score. The beginner level also has one player where the targets are slow balls aiming for static color-coded targets (LED Lights). The intermediate level has one to two bots (player+artificial intelligence (AI)) where the targets are rolling balls (pool table) and the gates switch colors and awards. The advanced level has two to three bots (Player(s)+AI) where the targets are smart or have behavior, the gates close and switch (windmill, swinging doors), and the players are subject to negative scoring (score for opponent).

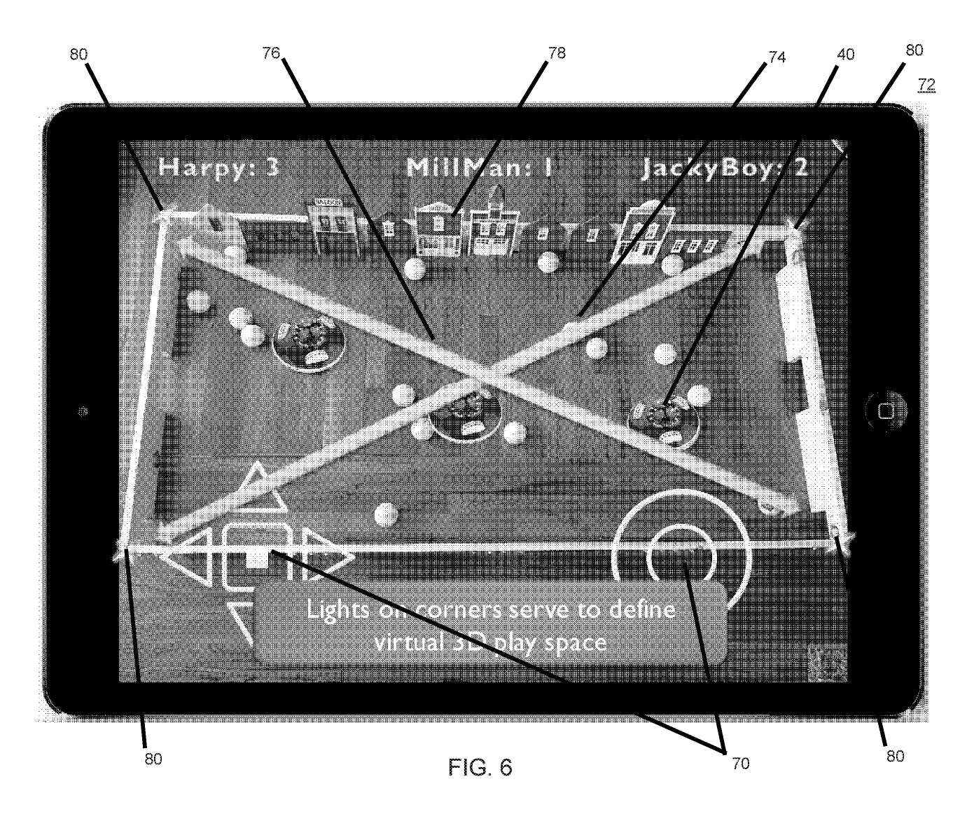

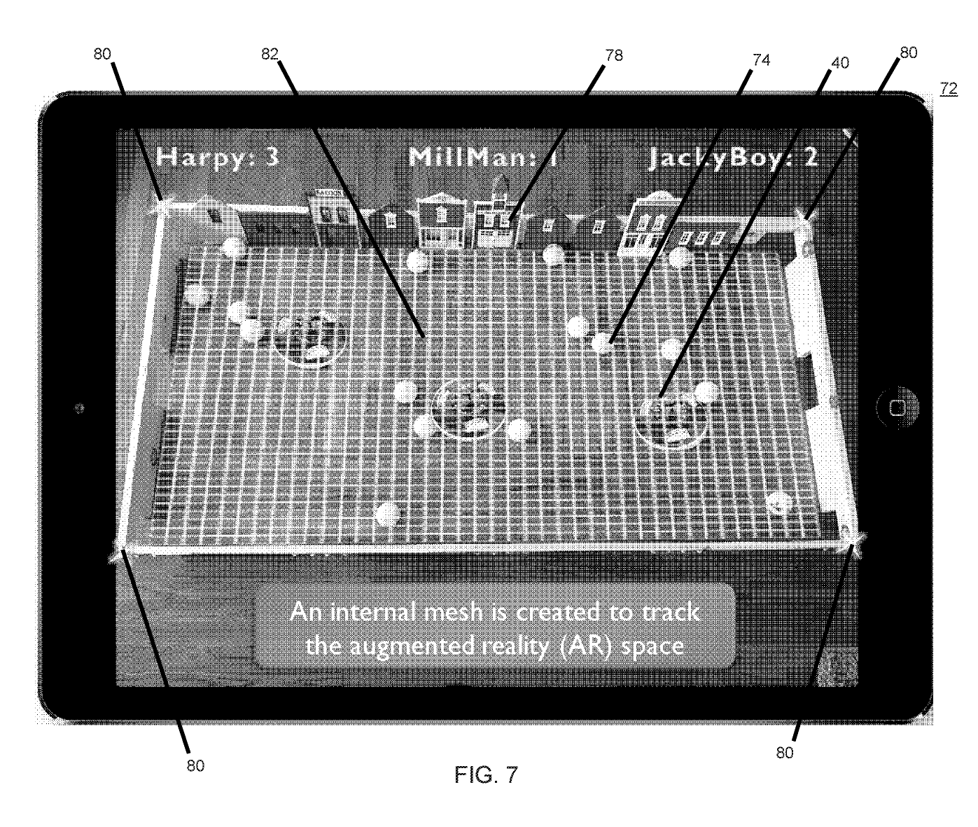

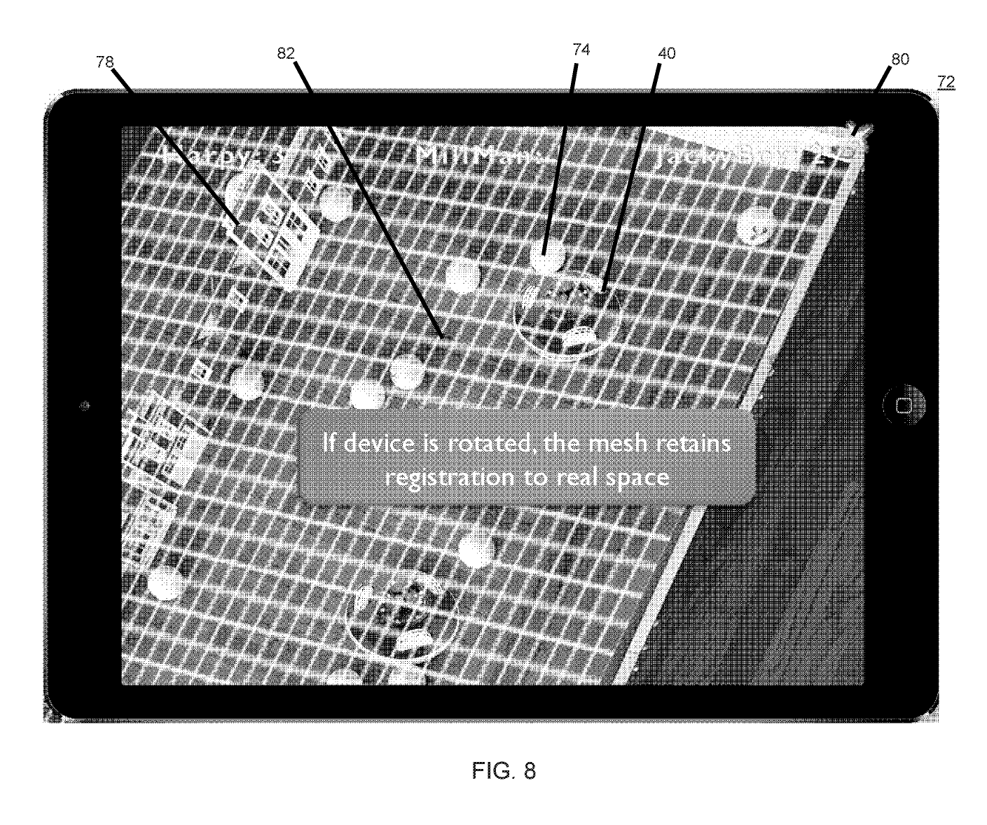

The virtual control overlay 70 allows the playing user to move or spin their robot 40. FIG. 6 illustrates tracking and calibration of the control device of FIG. 4 or FIG. 5 using lights 80 on the corners of the perimeter wall 78 to define a virtual three-dimensional (3D) play space. FIG. 7 illustrates the use of a mesh/grid 82 to track an augmented reality (AR) space associated with the playing surface 76 enclosed by the perimeter wall 78. As shown in FIG. 8 the registration of the augmented reality (AR) space with respect to real space is maintained even with rotation of the portable computing/gaming device 72 using the mesh/grid 82. It should be noted that the mesh/grid 82 is generally not visible to the user but is used for orientation between devices.

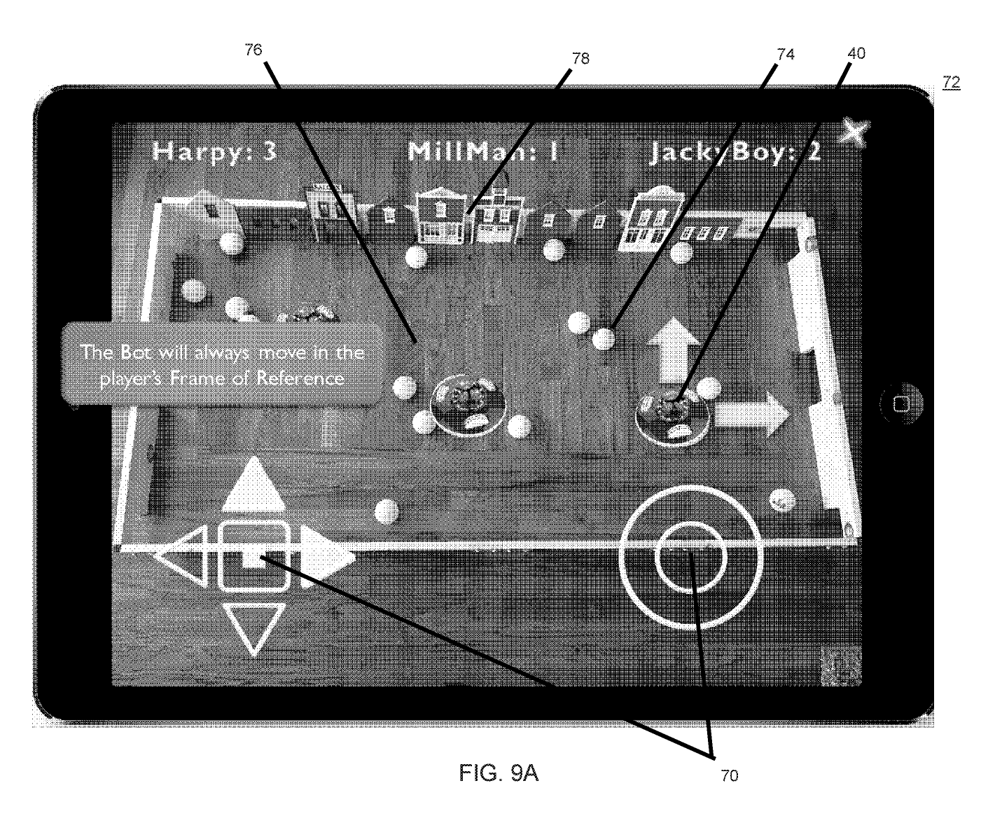

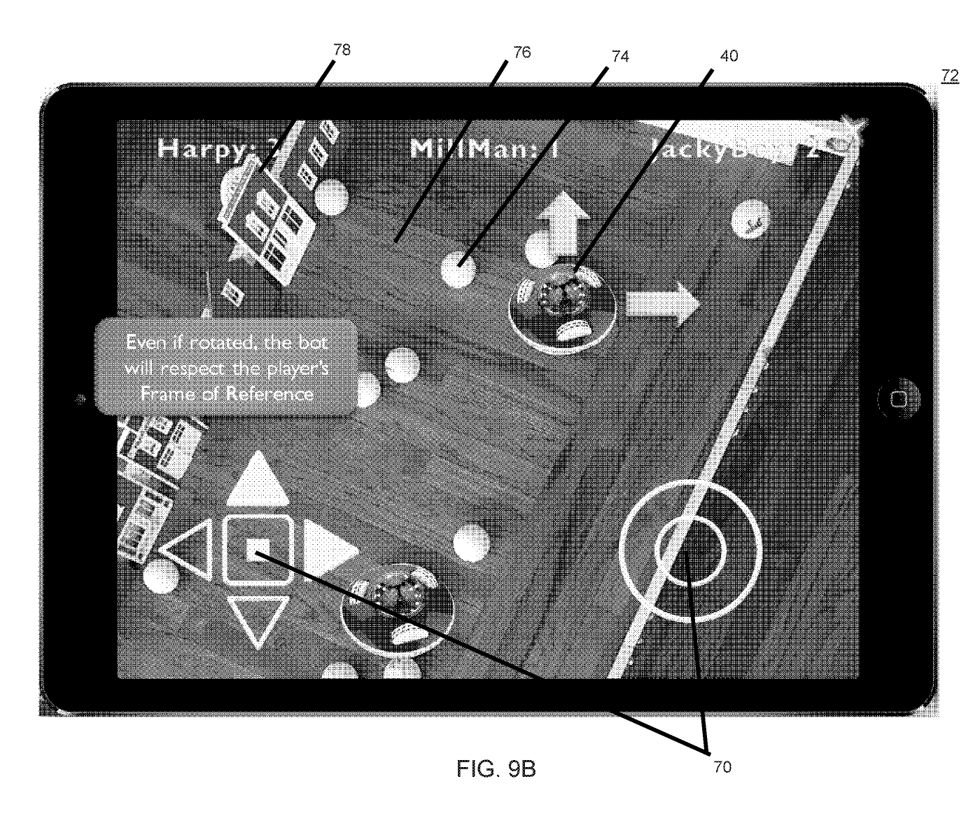

FIGS. 9A and 9B are screenshots from the portable computing/gaming device 72 that illustrate the maintaining of a player's frame of reference with movement of the portable computing/gaming device. As shown in FIG. 9B the robot 40 still moves in the same orientation as the hand held remote control device 72, even though the playing surface 76 is now rotated with respect to the frame of reference of the player and their remote device 72.

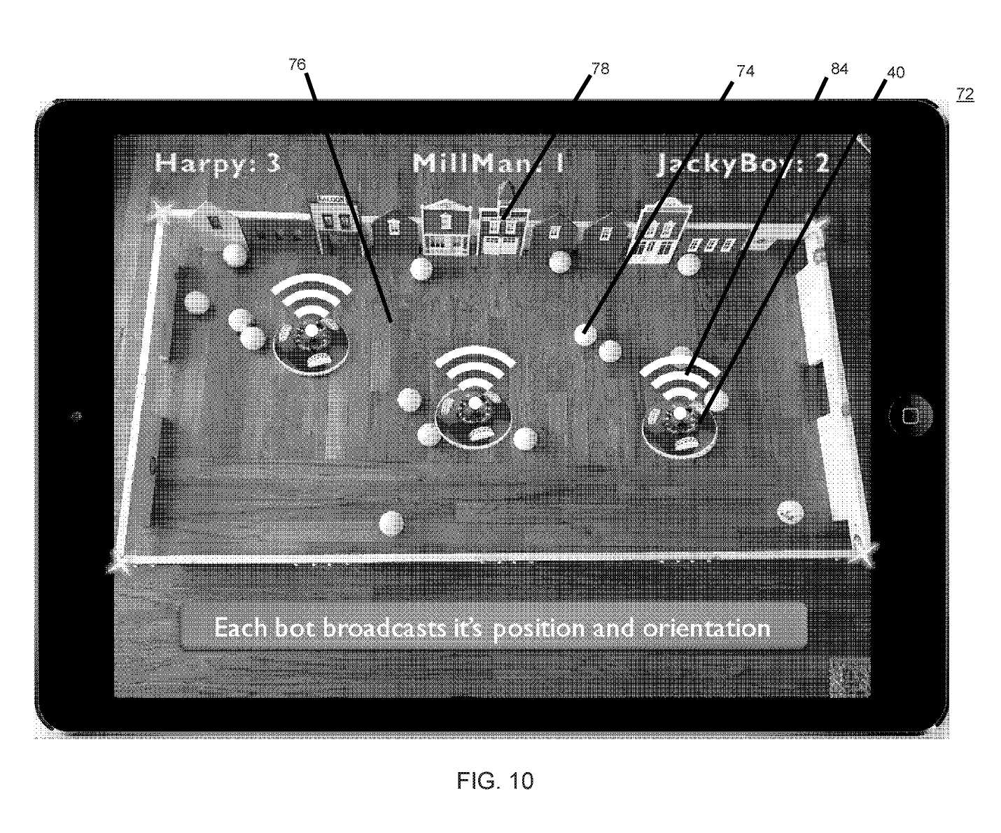

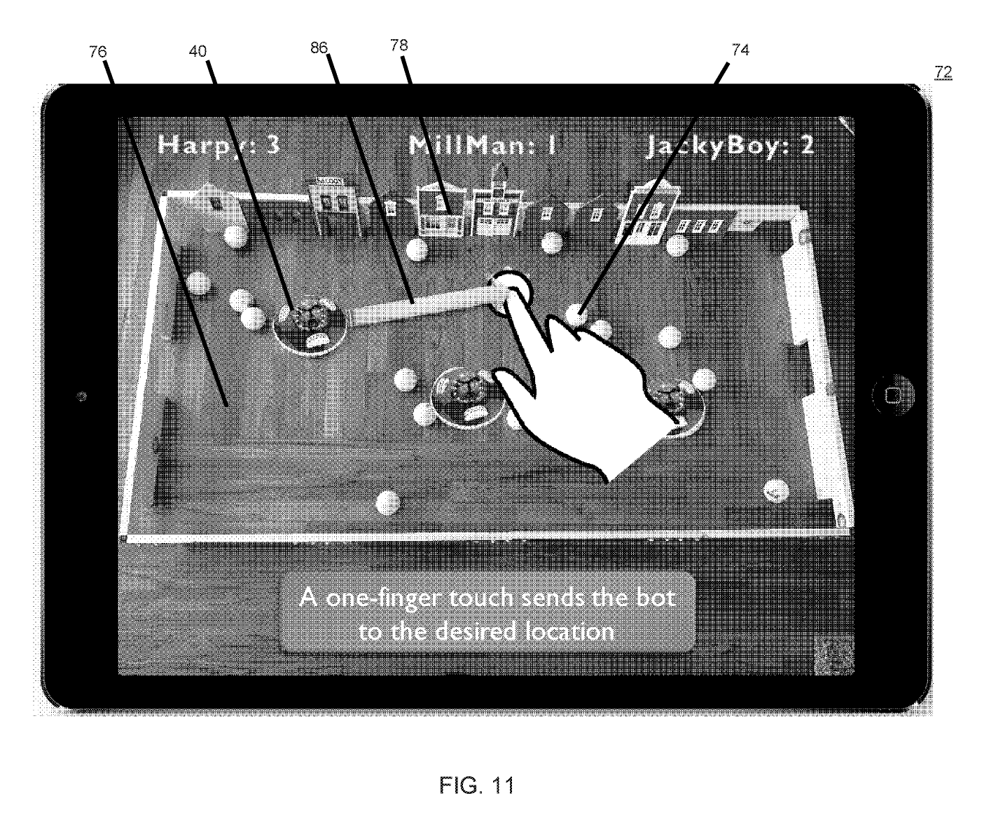

FIG. 10 illustrates the multi-function modular robot apparatuses 40 broadcasting position and orientation information (shown graphically as waves 84) to a corresponding remote control gaming device to maintain the frames of reference between the users and the robot(s) 40.

FIG. 11 illustrates touch control (shown as finger swipe 86 on the touch screen) to move the multi-function modular robot apparatus 40 to a desired location on a playing surface 76. The coordinates of the mesh/grid 82 is used to provide the location of the end point of the finger swipe to the robot 40.

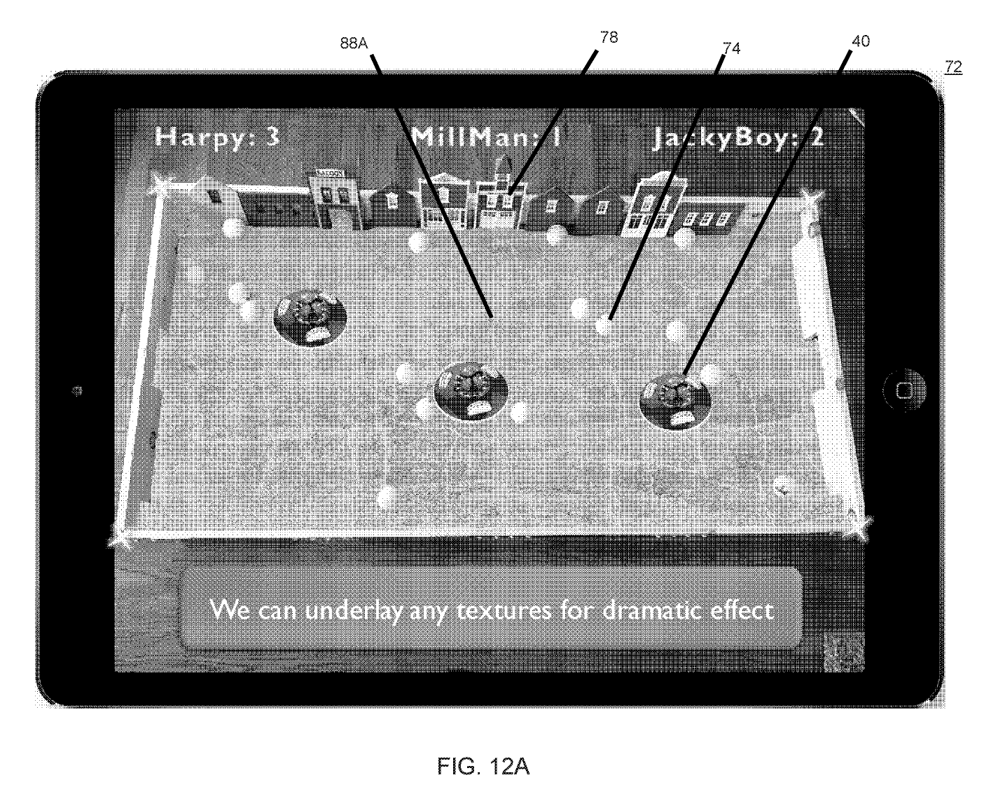

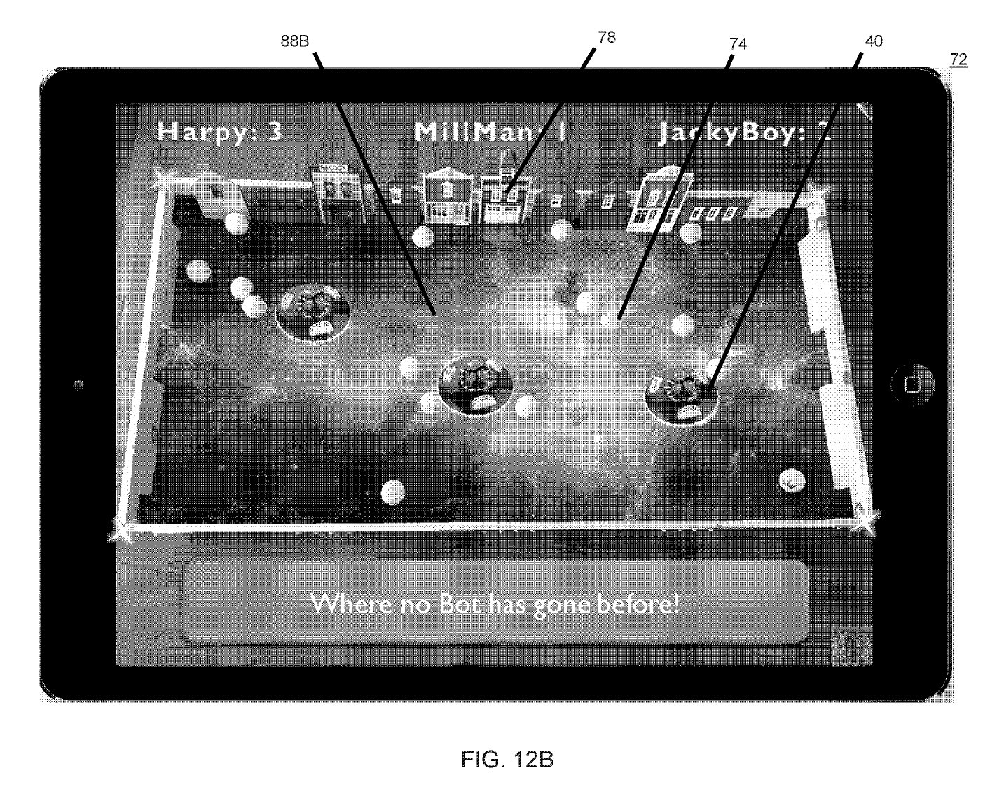

FIGS. 12A and 12B illustrate the use of electronically generated underlying playing fields or textures on the remote control gaming device screen for the use with the real life playing surface 76 for added dramatic effect. FIG. 12A shows a ground like texture 88A, while FIG. 12B uses a deep space motif 88B.

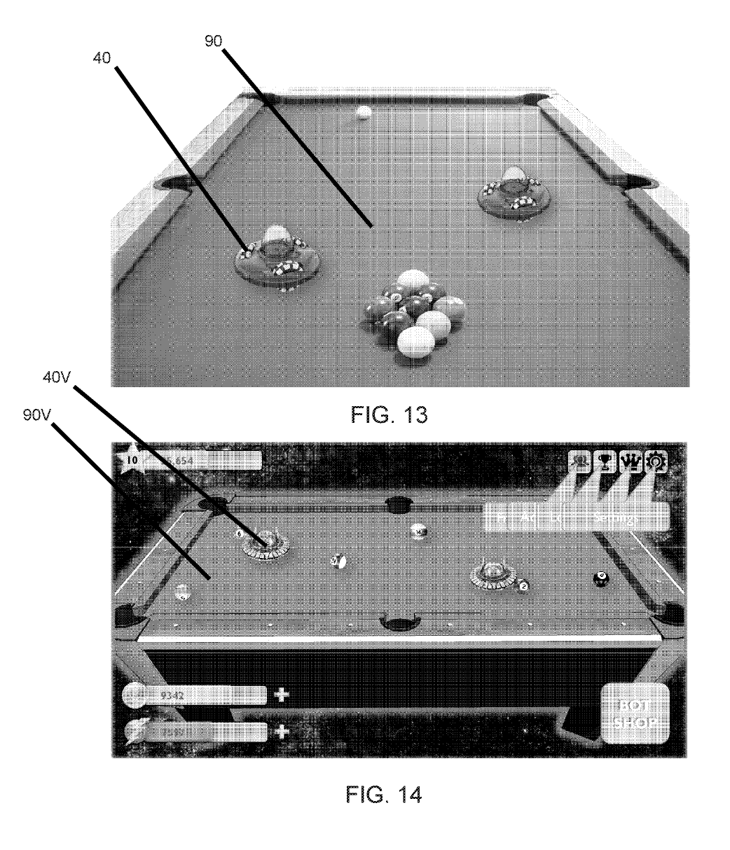

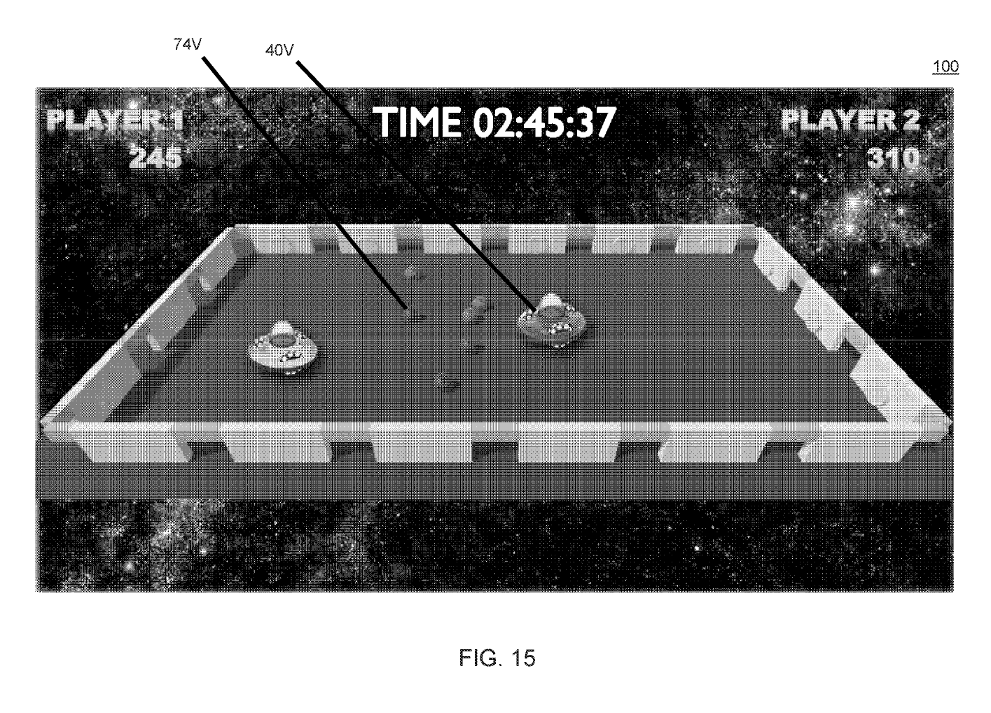

Embodiments of the inventive game system may also have a corresponding video game simulator, where a companion video game simulates the physical game so players can hone their game playing skills. Among the non-limiting features of the video game are a free-to-play game model; resource management, and time-based upgrades; realistic physics engine; upgrades and power-ups; players can sabotage and opponent's robot (Zoz); online multiplayer battles; leader boards and social interactions; and live competitions that may be held on the Internet. FIG. 13 illustrates a perspective view of a robot controlled game played on a billiards surface 90, while FIG. 14 illustrates a corresponding virtual or game simulator view of the robot controlled game played on a billiards surface 90V of FIG. 13. FIG. 15 illustrates an additional version 100 of a virtual or game simulator view of a robot controlled game.

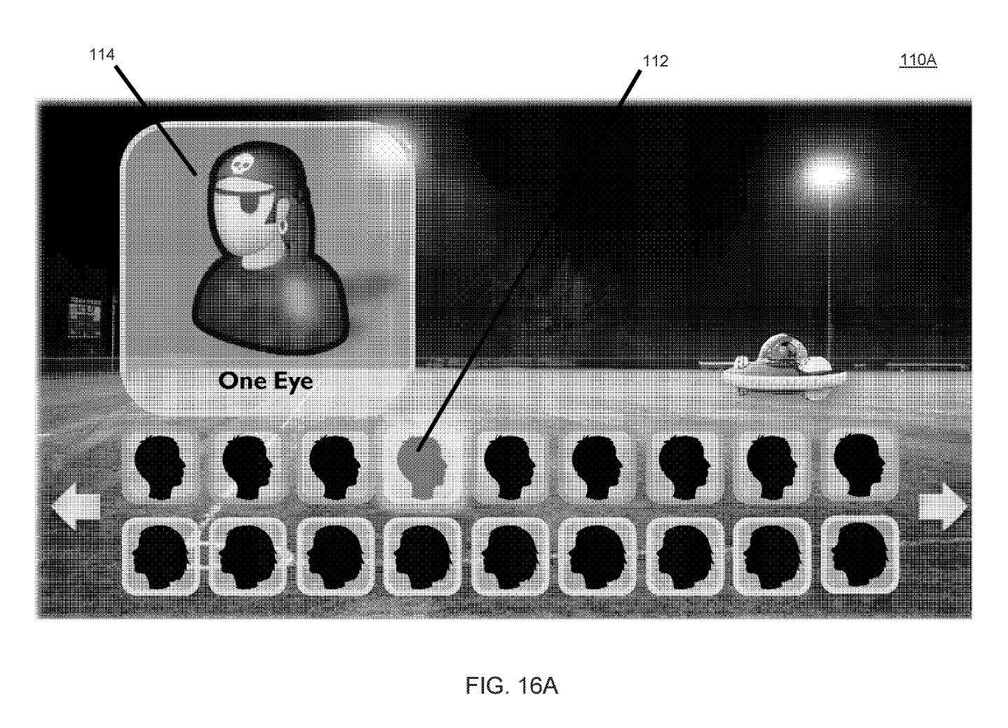

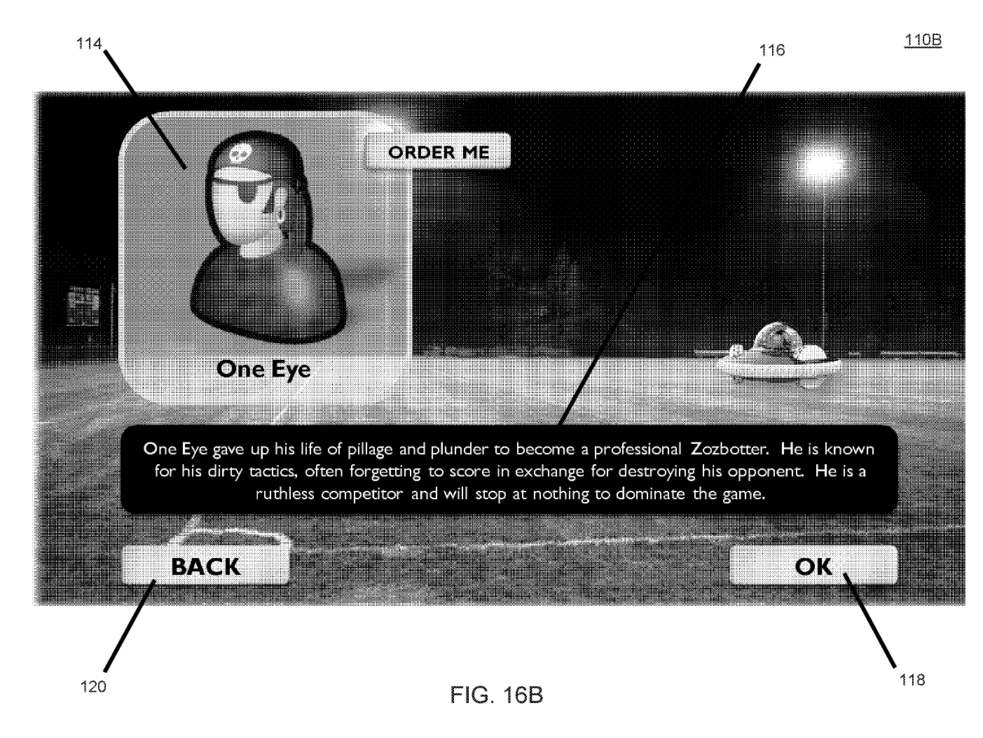

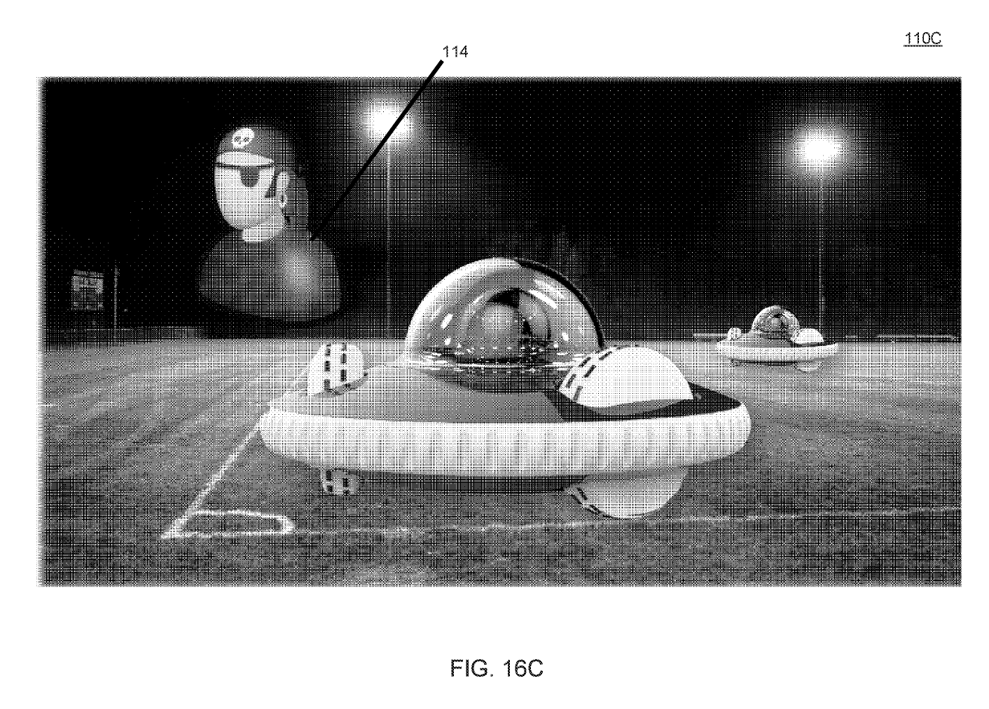

FIG. 16A and 16C illustrate a series of screenshots for selection of an avatar for game play. In FIG. 16A a screen shot 110A illustrates a user selecting an avatar 114 from a scrollable selection of avatars 112. In FIG. 16B a screen shot 110B provides a character backstory or biography 116 of the selected avatar with an “OK” button 118 to make a final selection of the chosen avatar, or a “BACK” button 120 to go back to screen 110A of FIG. 16A to choose a different avatar. FIG. 16C illustrates screen shot 110C and the selection of avatar 114.

Examples of characters for male avatars may illustratively include: a pirate as shown above, a storm trooper wearing futuristic armor, a rock star dressed in sunglasses and leather, a ninja, a skate boarder with a beanie and shaggy hair, an alien with big eyes and a big head, a demon with horns, red eyes, and bat wings, a nerd with glasses or a virtual reality (VR) headset, steampunk—Victorian theme with gadgets, an astronaut dresses in a bubble helmet, a cowboy dressed in a hat and chaps, movie based characters such as “Men In Black” dressed in black suits and sunglasses, a zombie dressed in rags and only bones, and Hip Hop based characters.

Examples of characters for female avatars may illustratively include: a pirate; ninja with pretty eyes; a dragon as a cute beast; a zombie in a dress in rags; a cowgirl dressed in boots and jeans; a steampunk—Victorian with gadgets, a cartoon character such as a Power Ranger in pink or green armor; a catwomen dressed in a leather outfit with cat ears; a movie character such as “Tomb Raider” dressed in shorts and a tank top and carrying guns or a “Transformer” as a female robot; a vampire in Goth cloths and fangs; an anime with big eyes, big head, and an Asian look; a raver dressed in a colorful outfit, beads, lights; and an astronaut.

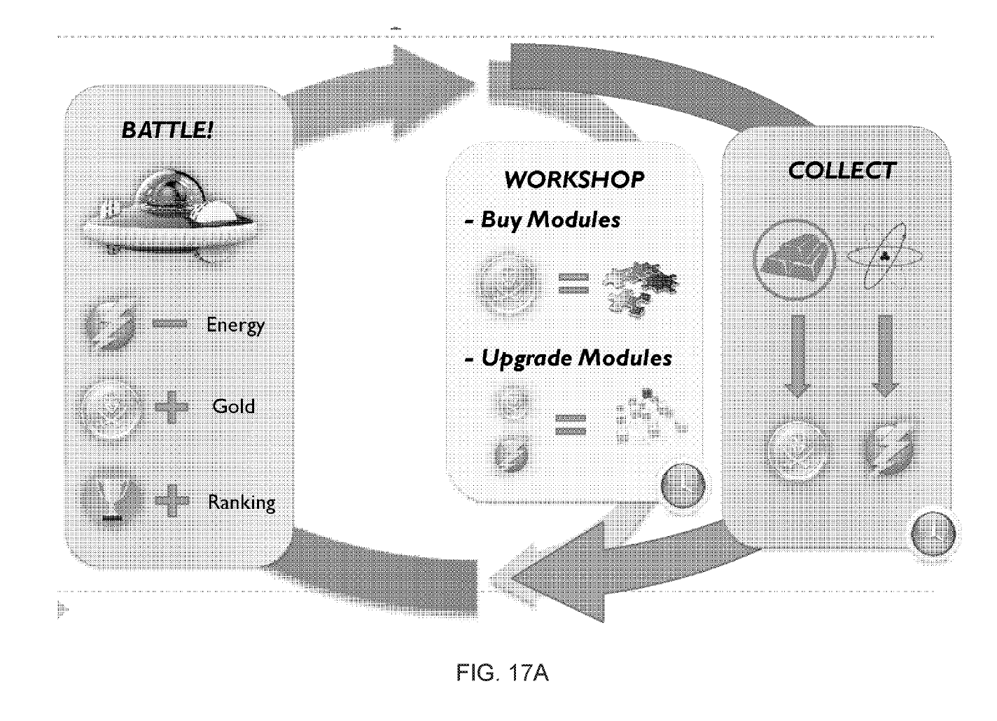

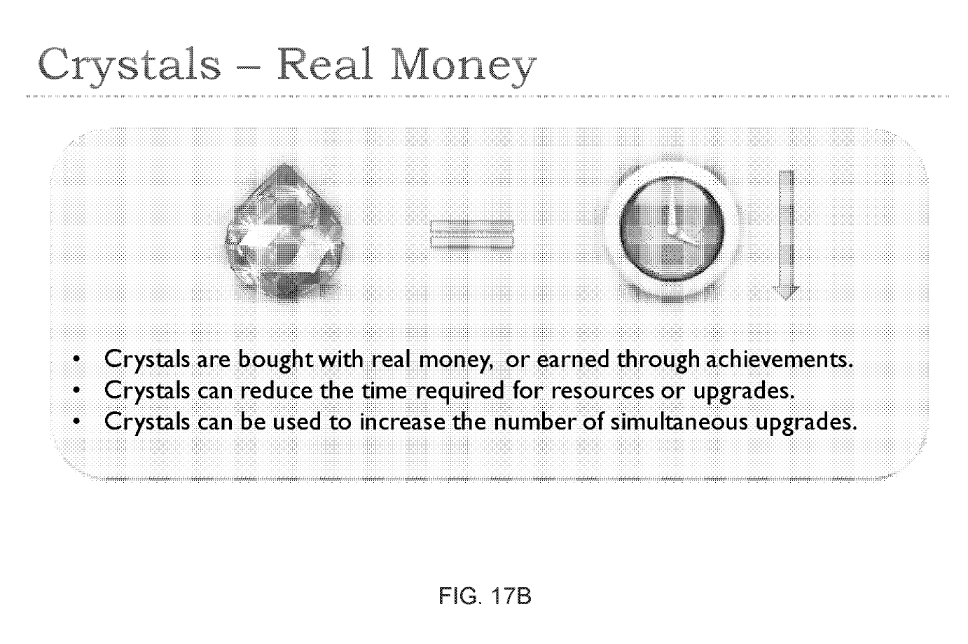

FIGS. 17A and 17B illustrate game objectives in accordance with embodiments of the invention. As shown in FIG. 17A the core game loops include battles that are conducted with robots that expend energy while acquiring gold and ranking. A player may use a workshop to buy modules for their robot with gold, or upgrade modules with gold and energy. Players can also collect gold and energy based on time performance. In FIG. 17B crystals may be bought with real money by a player or earned through achievements. Crystals can reduce the time required for resources or upgrades. Crystals can be used to increase the number of simultaneous upgrades. Crystals are designed for impatient players who don't want to wait to earn resources and upgrades based on achievements.

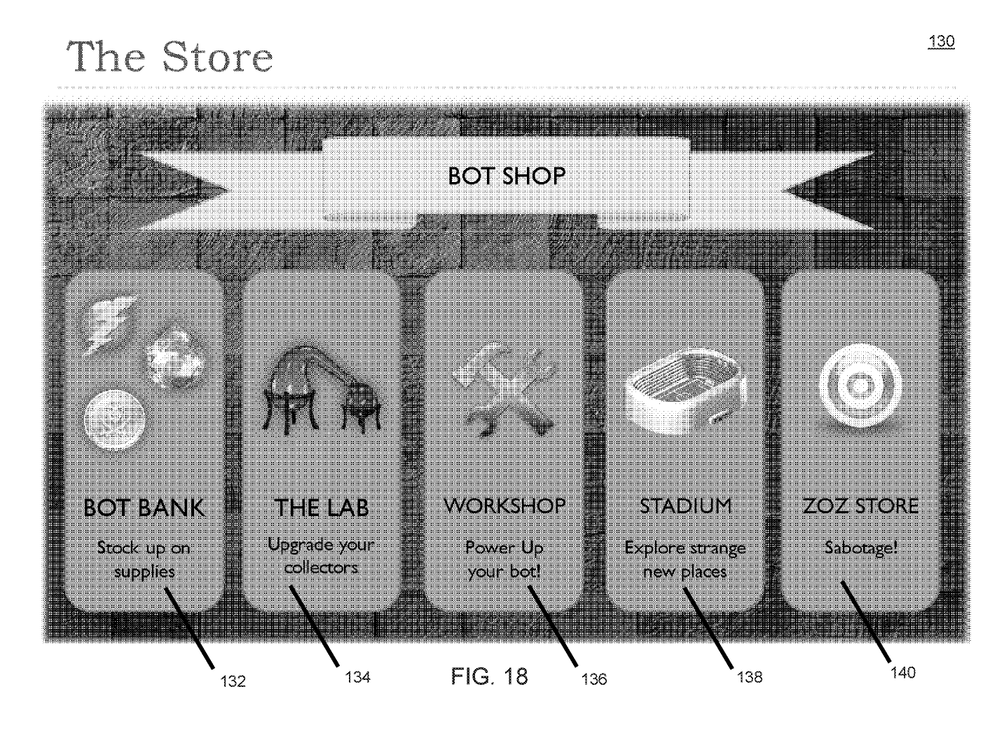

FIG. 18 is a screenshot of a game menu 130 for player options in the bot (robot) shop. Players may choose the “Bot Bank” 132 to stock up on supplies such as gold, energy, or crystals. The “Lab” 134 is used for upgrading a player's collectors or capacity to create gold or energy overtime. The “Workshop” 136 is used to buy modules and upgrade modules. The “Stadium” tab 138 is used to set up new venues for game play and explore strange new places. The “Zoz” store 140 is used by a player to sabotage their opponents.

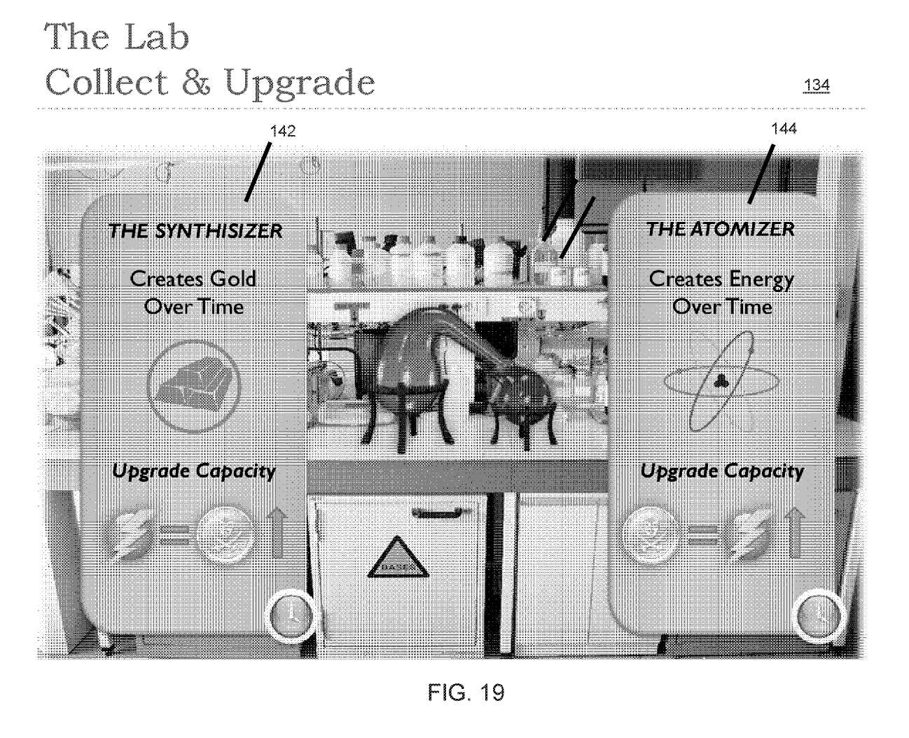

FIG. 19 is a screenshot of the Lab selection 134 from the game menu 130 of FIG. 18. The “Lab” 134 has a “Synthisizer” 142 that creates gold over time and upgrades the capacity of gold based on inputted energy. The “Lab” 134 has an “Atomizer” 144 that creates energy over time and upgrades the capacity of energy based on gold spent.

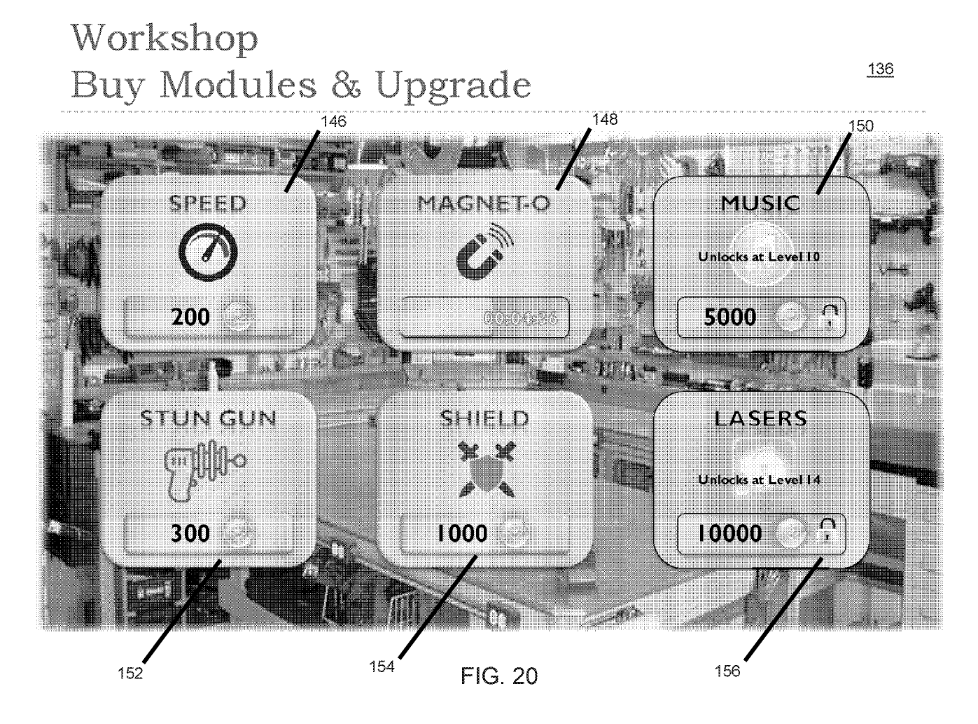

FIG. 20 is a screenshot of the Workshop selection 136 from the game menu 130 of FIG. 18. The “Workshop” may be used to buy modules or for upgrades to a player's robot. Upgrade options and associated costs in gold coins include speed 146, magnet-o 148, music 150, stun gun 152, shield 154, and laser 156. The magnet-o becomes available at a certain time threshold, while the music 150 and lasers unlock at specific levels of achievements.

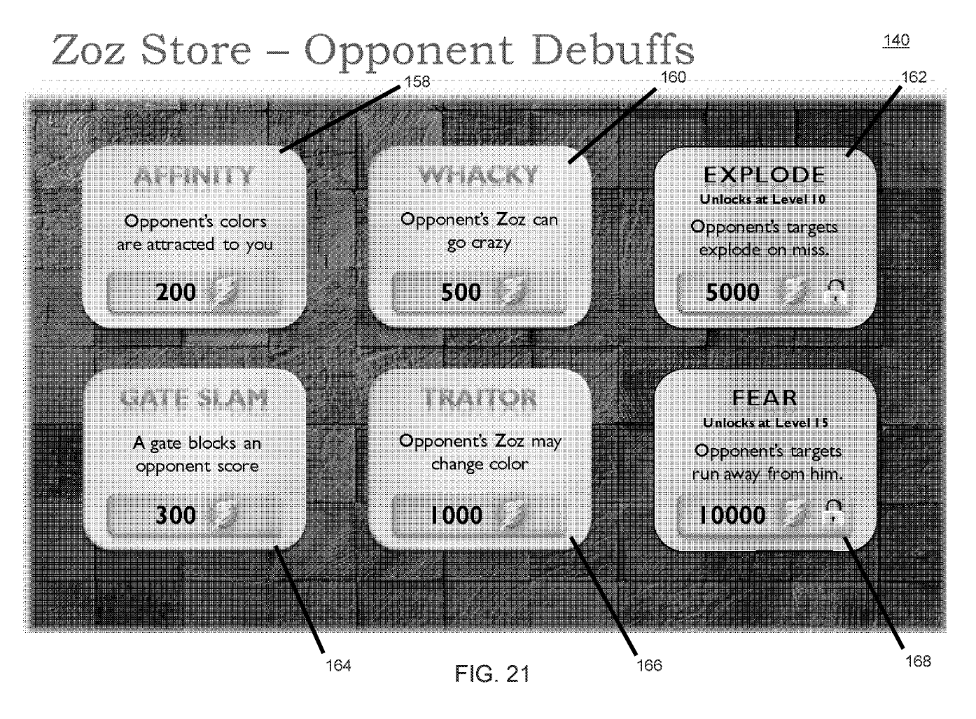

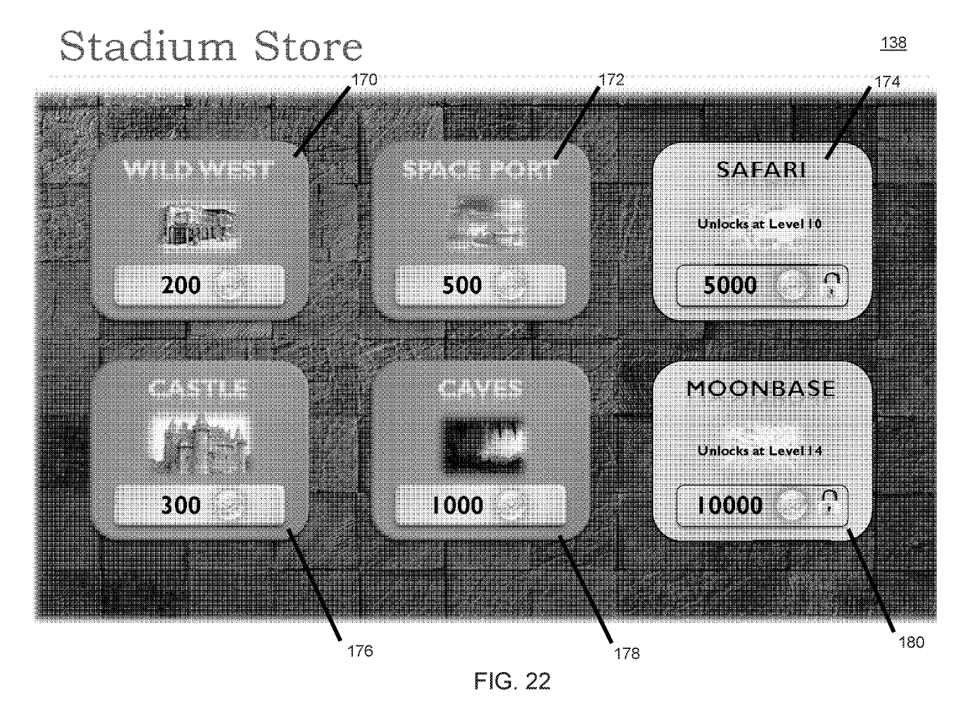

FIG. 21 is a screenshot of the “Zoz store” selection 140 from the game menu 130 of FIG. 18. A player uses the “Zoz store” 140 to “debuff” an opponent. Selections in the “Zoz store” 140 may be purchased with units of energy. Affinity 158 is purchased to attract an opponent's colors toward your robot to make it harder for the opponent to get to their balls. Whacky 160 may be used to make an opponent's balls (Zoz) go “crazy” i.e. the balls have erratic and unpredictable movements. The explode 162 option unlocks at a specific level of game achievement and causes an opponent's targets to explode on a miss. A gate slam 164 is used to block an opponent from scoring. The traitor option 186 may cause an opponent's ball (zoz) to change colors. The fear 168 option unlocks at a specific level of game achievement and causes an opponent's targets to run away from them.

FIG. 22 is a screenshot of the Stadium store selection 138 from the game menu 130 of FIG. 18. The “Stadium” tab 138 is used to set up new venues for game play and explore strange new places. Examples of stadium venues include wild west (shoot 'em up) 170, space port 172, African safari 174, medieval castle (dragon) 176, caves (bats) 178, and moon base 180. Additional non-limiting examples may illustratively include a spooky swamp, an arctic landscape (Yeti), a tropical paradise (volcano!), and jagged mountains.

The foregoing description is illustrative of particular embodiments of the invention, but is not meant to be a limitation upon the practice thereof. The following claims, including all equivalents thereof, are intended to define the scope of the invention.

1. A remote control device orientation system comprising:
a remote control;
a controlled object in electrical communication with said remote control; and
wherein said remote control and said controlled object include both an electronic inertial guidance system and at least one device configured to determine the relative orientation and frame of reference of said remote control with respect to said controlled object.

2. The system of claim 1 wherein said remote control comprises at least one of dedicated remote devices, mobile computing devices, entertainment devices and tablets, or smart phones.

3. The system of claim 1 wherein said controlled objects further comprise a robot, a vehicle, a model boat, a model airplane, or a drone.

4. The system of claim 1 wherein said electronic inertial guidance system further comprises one or more of a computer, accelerometers, gyroscopes, and magnetometers.

5. The system of claim 4 further comprising one or more devices with capabilities including visual, global positioning satellite (GPS), sound, radio waves, light, infra red (IR), laser, magnetic, where the capabilities are used to determine the relative orientation of the controller with respect to said controlled object.

6. The system of claim 1 wherein said controlled object is an omni-bot that changes direction instantaneously without steering with the use of a set of three independent wheels, where each of said three independent wheels has a dedicated motor.

7. The system of claim 6 wherein said omni-bot further comprises a module interface cutout adapted to receive stackable modules, each of said stackable modules providing one or more functions.

8. The system of claim 7 wherein said stackable module functions further comprise a computer driver module, a motor driver module, a display module, a lights module, light emitting diodes (LED), a camera module, a sound and music module, a turret module, weapons module, inertial guidance system, and a communications module. Additional modules that may be added or interchanged in the stack include a telescope module, a weapons module, a tilting module, a spring module (for a bobble head), a bellows module, and a quick response (QR) code scanner module, robot arms, probes, sensors, a smoke and fog machine module, a universal serial bus (USB) port module, an infrared detector module, a laser range detector module, a sonic range detector module, a motion detector module, a multi laser light show module, a battery module, an auxiliary jack input module, a speaker module, a video projector module, a microphone module, a smoke detector module, and a carbon monoxide detector module.

9. The system of claim 8 wherein said display module further comprises a clear dome positioned at a top portion of said stackable modules, and said display module has one or a combination of: video screen displays, avatars, heads, bobble-heads, arms, hands, sculptures, models, mini robots, animatronics, and art.

10. The system of claim 1 wherein said remote control device further comprises a virtual control overlay on a touch screen, where said remote control device compensates for orientation changes to both said remote control unit and said controlled object, relative to each other, without affecting directional control of said controlled object.

11. The system of claim 1 further comprising a playing field, where said playing field further comprises one of a floor, a table top, or a billiards table.

12. The system of claim 11 wherein said playing field is enclosed by a perimeter wall, where said perimeter wall has a set of goals or openings.

13. The system of claim 12 further comprising a set of color-coded ball, where said controlled objects push selected balls from said set of color-coded balls through said set of goals or openings.

14. The system of claim 12 wherein said set of goals or openings further comprise a set of opening and closing gates.

15. The system of claim 12 further comprising a set of lights on a set of corners of said perimeter wall that define a virtual three-dimensional (3D) play space.

16. The system of claim 15 further comprising a mesh/grid overlaid on said playing field to track an augmented reality (AR) space associated with said playing surface;
wherein a registration of the augmented reality (AR) space with respect to a real space occupied by said playing field is maintained even with rotation of said remote control device using said mesh/grid.

17. The system of claim 16 wherein said remote control device further comprises a touch screen, where a set of coordinates provided by said mesh/grid in conjunction with a finger swipe of said touch screen repositions said controlled device at an end point of the finger swipe.

18. The system of claim 17 further comprising a set of electronically generated underlying playing fields or textures on said touch screen for the use with said playing surface.

19. The system of claim 18 further comprising a video game simulator.

20. A method of using the system of claim 1 comprising:
establishing an initial common vector between said remote control and said controlled object to determine an initial frame or reference;
calculating a delta angle between the initial common vector and a current vector as the controller changes orientation;
sending the controller calculated delta angle to the controlled object; and
establishing a new frame of reference for the controlled object.
